(19) United States
(12) Patent Application Publication
(10) Pub. No.: US 2021/0407432 A1
(43) Pub. Date: Dec. 30, 2021

(54) LIGHT-EMITTING SCANNING SIGNAL DRIVE CIRCUIT, DISPLAY PANEL, AND ELECTRONIC DEVICE

(71) Applicant: SHENZHEN ROYOLE TECHNOLOGIES CO., LTD., Shenzhen (CN)

(72) Inventors: Weiyao WEI, Shenzhen (CN); Yao YAN, Shenzhen (CN); Jiha KIM, Shenzhen (CN)

(21) Appl. No.: 17/361,759

(22) Filed: Jun. 29, 2021

(30) Foreign Application Priority Data
Jun. 30, 2020 (CN) 202010615060.X

(51) Int. Cl. G09G 3/3266

(52) U.S. Cl. CPC G09G 3/3266; G09G 2300/0842; G09G 2310/08

(57) ABSTRACT

The present disclosure provides a light-emitting scanning signal drive circuit, a display panel and an electronic device. The light-emitting scanning signal drive circuit includes: an enable signal generation circuit and a regulation circuit, where the enable signal generation circuit is configured to receive a first voltage signal and includes a pull-up point, a pull-down point and an output terminal, the pull-up point is electrically connected to the regulation circuit, the pull-down point is electrically connected to the regulation circuit, the regulation circuit is configured to receive a second voltage signal and input the second voltage signal to the enable signal generation circuit, and the enable signal generation circuit generates a high-potential enable signal based on the first voltage signal and the second voltage signal and outputs the high-potential enable signal via the output terminal. The leakage current of the enable signal generation circuit is reduced.

### TECHNICAL FIELD

The present disclosure relates to the field of display technologies, and in particular, to a light-emitting scanning signal drive circuit, a display panel, and an electronic device.

### BACKGROUND

Display technologies for electronic devices have always been one of key research directions. Generally, a display panel includes a light-emitting scanning signal drive circuit, and the light-emitting scanning signal drive circuit outputs an enable signal to drive a light-emitting unit in the display panel to emit light.

At present, when the light-emitting scanning signal drive circuit is in a high-temperature environment, due to device characteristics of thin film transistors, a threshold voltage is negatively biased, and a leakage current increases. As a result, when the light-emitting scanning signal drive circuit outputs the enable signal, a voltage value of the output enable signal decreases, which leads to a brightness change of the light-emitting unit and abnormal display of the display panel.

### SUMMARY

The present disclosure discloses a light-emitting scanning signal drive circuit, which can solve the technical problem that when a light-emitting scanning signal drive circuit outputs an enable signal, a voltage value of the output enable signal decreases.

According to a first aspect, the present disclosure discloses a light-emitting scanning signal drive circuit, applied to a display panel, where the light-emitting scanning signal drive circuit includes: a voltage signal generation circuit, an enable signal generation circuit and a regulation circuit, the voltage signal generation circuit is configured to generate a first voltage signal and a second voltage signal, the enable signal generation circuit receives the first voltage signal and includes a pull-up point, a pull-down point and an output terminal, the pull-up point is electrically connected to the regulation circuit, the pull-down point is electrically connected to the regulation circuit, the regulation circuit is configured to receive the second voltage signal and input the second voltage signal to the enable signal generation circuit, and the enable signal generation circuit generates a high-potential enable signal based on the first voltage signal and the second voltage signal and outputs the high-potential enable signal via the output terminal, where a voltage value of the second voltage signal is greater than that of the first voltage signal.

The regulation circuit regulates a leakage current of the enable signal generation circuit based on the second voltage signal, so that the leakage current of the enable signal generation circuit is reduced, thereby keeping the enable signal generated by the enable signal generation circuit stable.

According to a second aspect, the present disclosure further provides a light-emitting scanning signal drive circuit, including a second voltage signal line and an enable signal generation circuit, where the enable signal generation circuit includes a pull-up point and a first transistor, the first transistor includes a first gate, a second gate, a first electrode and a second electrode, the first gate of the first transistor is electrically connected to the second gate and configured to receive a first clock signal, the first clock signal is used to control on-off of the first transistor, the first electrode of the first transistor is electrically connected to the pull-up point, the second electrode of the first transistor is electrically connected to the second voltage signal line, and the first transistor charges the pull-up point through the second voltage signal.

According to a third aspect, the present disclosure further provides a display panel, including the light-emitting scanning signal drive circuits described in the first aspect and second aspect.

According to a fourth aspect, the present disclosure further provides an electronic device, including a body and the display panel described in the third aspect, where the body is configured to bear the display panel.

### BRIEF DESCRIPTION OF DRAWINGS

To illustrate the technical solutions in the implementations of the present disclosure more clearly, accompanying drawings required for the implementations are briefly introduced below. Apparently, the accompanying drawings in the following description show merely some of the implementations of the present disclosure, and a person of ordinary skill in the art can still derive other accompanying drawings based on these accompanying drawings without creative efforts.

FIG. 1 is a schematic block diagram illustrating a light-emitting scanning signal drive circuit according to a first implementation of the present disclosure;

FIG. 2 is a schematic diagram illustrating a light-emitting scanning signal drive circuit according to a first embodiment of the present disclosure;

FIG. 3 is a schematic diagram illustrating a light-emitting scanning signal drive circuit according to a second embodiment of the present disclosure;

FIG. 4 is a schematic diagram illustrating a light-emitting scanning signal drive circuit according to a third embodiment of the present disclosure;

FIG. 5 is a schematic diagram illustrating a light-emitting scanning signal drive circuit according to a fourth embodiment of the present disclosure;

FIG. 6 is a schematic diagram illustrating a light-emitting scanning signal drive circuit according to a second implementation of the present disclosure;

FIG. 7 is a schematic block diagram illustrating a display panel according to an embodiment of the present disclosure; and

FIG. 8 is a schematic top view illustrating an electronic device according to an embodiment of the present disclosure.

### DESCRIPTION OF EMBODIMENTS

The following clearly and completely describes the technical solutions in the implementations of the present disclosure with reference to the accompanying drawings in the implementations of the present disclosure. Apparently, the described implementations are merely some rather than all implementations of the present disclosure. All other implementations obtained by a person of ordinary skill in the art based on the implementations of the present disclosure without creative efforts shall fall within the scope of protection of the present disclosure.

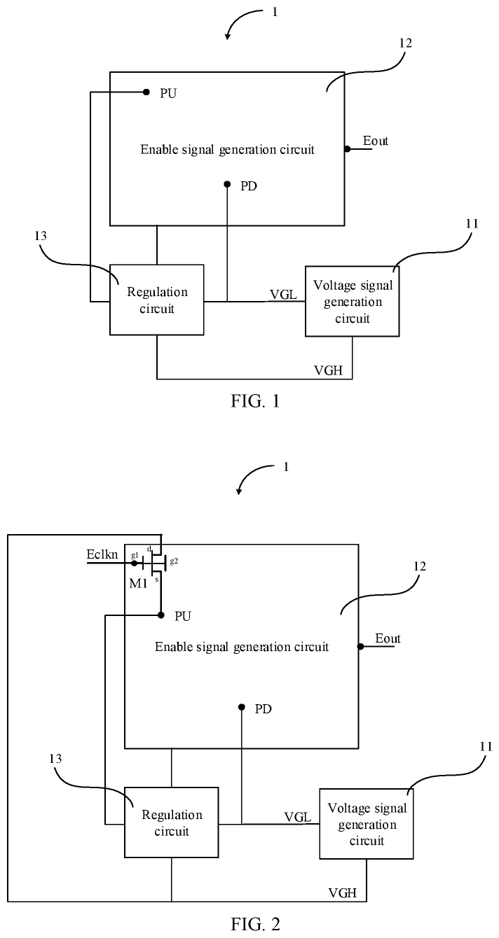

The present disclosure provides a light-emitting scanning signal drive circuit 1. Referring to FIG. 1, FIG. 1 is a schematic block diagram illustrating a light-emitting scanning signal drive circuit according to a first implementation of the present disclosure. The light-emitting scanning signal drive circuit 1 includes: a voltage signal generation circuit 11, an enable signal generation circuit 12 and a regulation circuit 13, where the voltage signal generation circuit 11 is configured to generate a first voltage signal VGL and a second voltage signal VGH, and the enable signal generation circuit 12 receives the first voltage signal VGL; the enable signal generation circuit 12 includes a pull-up point PU, a pull-down point PD and an output terminal Eout, the pull-up point PU is electrically connected to the regulation circuit 13, the pull-down point PD is electrically connected to the regulation circuit 13, the regulation circuit 13 is configured to receive the second voltage signal VGH and input the second voltage signal VGH to the enable signal generation circuit 12, and the enable signal generation circuit 12 generates a high-potential enable signal based on the first voltage signal VGL and the second voltage signal VGH and outputs the high-potential enable signal via the output terminal Eout, where a voltage value of the second voltage signal VGH is greater than that of the first voltage signal VGL.

Specifically, the light-emitting scanning signal drive circuit 1 is generally applied to a display panel. The enable signal generated by the enable signal generation circuit 12 can drive a light-emitting unit in the display panel to emit light, so as to display an image.

It should be noted that the voltage signal generation circuit 11 is included in the light-emitting scanning signal drive circuit 1, that is, the first voltage signal VGL and the second voltage signal VGL generated by the voltage signal generation circuit 11 are internal signals of the light-emitting scanning signal drive circuit 1, without requiring the assistance of another voltage signal generation device, such as a chip and an additional power supply device.

Specifically, the enable signal generation circuit 12 further includes multiple thin film transistors, and the regulation circuit 13 inputs the second voltage signal VGH to the thin film transistors in the enable signal generation circuit 12 and controls the thin film transistors via the pull-up point PU and the pull-down point PD. Because the voltage value of the second voltage signal VGH is greater than that of the first voltage signal VGL, a source-gate voltage value of the thin film transistors is less than zero. According to a current-voltage characteristic curve of the thin film transistors, it can be concluded that when the source-gate voltage value of the thin film transistors is less than zero, a leakage current of the thin film transistors is greatly reduced, that is, a leakage current of the pull-up point PU is greatly reduced.

It can be understood that because multiple nodes in the light-emitting scanning signal drive circuit 1 need to receive the first voltage signal VGL and the second voltage signal VGH simultaneously, the voltage signal generation circuit 11 saves a design space and reduces a hardware cost of the light-emitting scanning signal drive circuit 1.

It can be understood that in this embodiment, the regulation circuit 13 regulates a leakage current of the enable signal generation circuit 12 based on the second voltage signal VGH, so that the leakage current of the enable signal generation circuit 12 is reduced, thereby keeping the enable signal generated by the enable signal generation circuit 12 stable.

In a possible embodiment, referring to FIG. 2, FIG. 2 is a schematic diagram illustrating a light-emitting scanning signal drive circuit according to a first embodiment of the present disclosure. The enable signal generation circuit 12 includes a first transistor M1, the first transistor M1 includes a first gate g1, a second gate g2, a first electrode s and a second electrode d, the first gate g1 of the first transistor M1 is electrically connected to the second gate g2 and configured to receive a first clock signal Eclkn, the first clock signal Eclkn is used to control on-off of the first transistor M1, the first electrode s of the first transistor M1 is electrically connected to the pull-up point PU, the second electrode d of the first transistor M1 is configured to receive the second voltage signal VGH, and the first transistor M1 charges the pull-up point PU through the second voltage signal VGH.

Specifically, when the first clock signal Eclkn is at a high potential, the first transistor M1 is turned on, so that the second voltage signal VGH charges the pull-up point PU. In this embodiment, the second voltage signal VGH is a direct current voltage signal. Compared with a conventional alternating current voltage signal, the second voltage signal VGH charges the pull-up point PU faster, which is beneficial to maintaining the voltage value of the pull-up point PU.

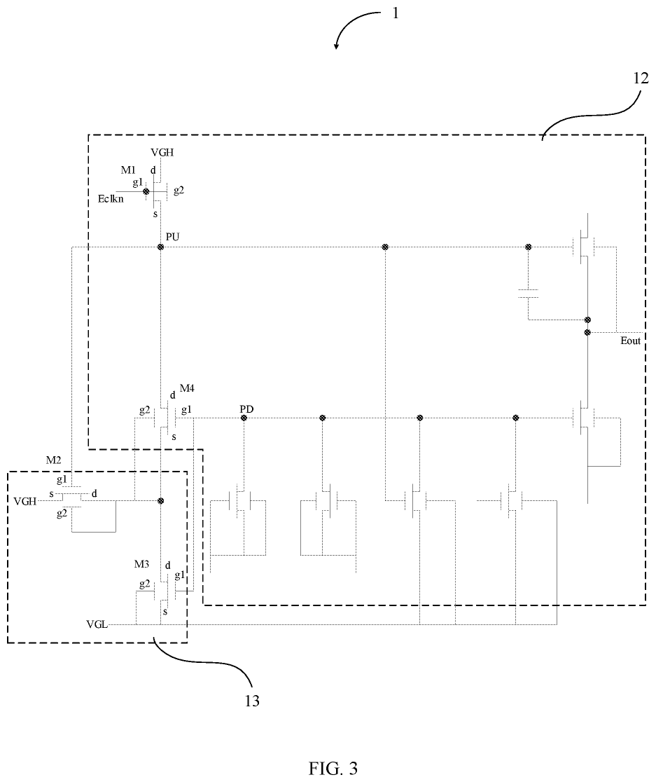

In a possible embodiment, referring to FIG. 3, FIG. 3 is a schematic diagram illustrating a light-emitting scanning signal drive circuit according to a second embodiment of the present disclosure. The regulation circuit 13 includes a second transistor M2 and a third transistor M3, and the enable signal generation circuit 12 includes a fourth transistor M4; the second transistor M2, the third transistor M3 and the fourth transistor M4 each include a first gate g1, a second gate g2, a first electrode s and a second electrode d; the first gate g1 of the second transistor M2 is electrically connected to the pull-up point PU, the second gate g2 of the second transistor M2 is electrically connected to the second electrode d of the third transistor M3, the first electrode s of the second transistor M2 is configured to receive the second voltage signal VGH, and the second electrode d of the second transistor M2 is electrically connected to the second electrode d of the third transistor M3; the first gate g1 of the third transistor M3 is electrically connected to the pull-down point PD, the first electrode s of the third transistor M3 is electrically connected to the second gate g2 of the third transistor M3 and configured to receive the first voltage signal VGL, and the second electrode d of the third transistor M3 is electrically connected to the second gate g2 of the fourth transistor M4; the first gate g1 of the fourth transistor M4 is electrically connected to the pull-down point PD, the second gate g2 of the fourth transistor M4 is electrically connected to the second electrode d of the third transistor M3, the first electrode s of the fourth transistor M4 is electrically connected to the second electrode d of the second transistor M2, and the second electrode d of the fourth transistor M4 is electrically connected to the pull-up point PU.

Specifically, when the charging of the pull-up point PU by the second voltage signal VGH is completed, the pull-up point PU maintains at a high voltage. The first voltage signal VGL is input to the pull-down point PD, and because the pull-up point PU maintains a high potential, the second transistor M2 is turned on, so that the second voltage signal VGH is transmitted to the first electrode s of the fourth transistor M4 through the second transistor M2. In this embodiment, because the voltage value of the second voltage signal VGH is greater than that of the first voltage signal VGL, a voltage value between the first gate g1 of the fourth transistor M4 and the first electrode s of the fourth transistor M4 is less than 0 V. According to the current-voltage characteristic curve of the thin film transistors, it can be concluded that a leakage current of the fourth thin film transistors M4 is greatly reduced, so that the leakage current of the pull-up point PU is greatly reduced.

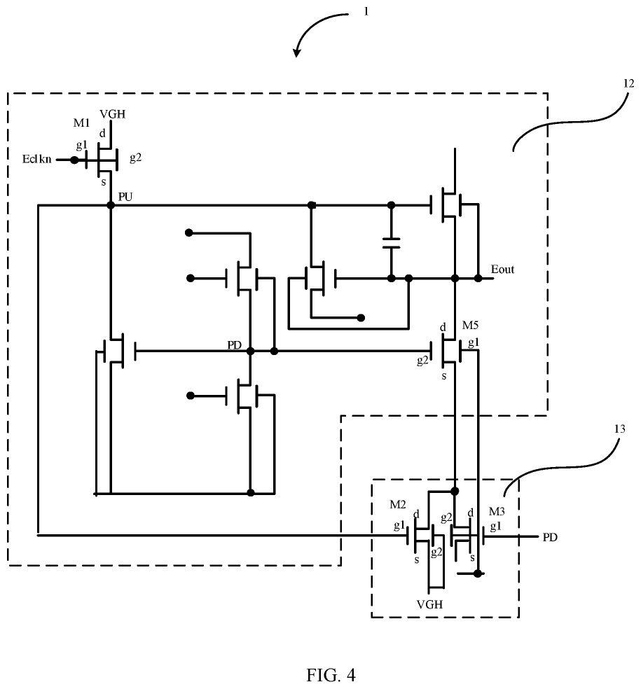

In a possible embodiment, referring to FIG. 4, FIG. 4 is a schematic diagram illustrating a light-emitting scanning signal drive circuit according to a third embodiment of the present disclosure. The regulation circuit 13 includes a second transistor M2 and a third transistor M3, and the enable signal generation circuit 12 includes a fifth transistor M5; the second transistor M2, the third transistor M3 and the fifth transistor M5 each include a first gate g1, a second gate g2, a first electrode s and a second electrode d; the first gate g1 of the second transistor M2 is electrically connected to the pull-up point PU, the second gate g2 of the second transistor M2 is electrically connected to the first electrode s of the second transistor M2 and configured to receive the second voltage signal VGH, and the second electrode d of the second transistor M2 is electrically connected to the second electrode d of the third transistor M3; the first gate g1 of the third transistor M3 is electrically connected to the pull-down point PD, the second gate g2 of the third transistor M3 is electrically connected to the first gate g1 of the fifth transistor M5 and configured to receive the first voltage signal VGL, and the second electrode d of the third transistor M3 is electrically connected to the first electrode s of the fifth transistor M5; the second gate g2 of the fifth transistor M5 is electrically connected to the pull-down point PD, and the second electrode d of the fifth transistor M5 is electrically connected to the output terminal Eout.

Specifically, when charging of the pull-up point PU by the second voltage signal VGH is completed, the pull-up point PU maintains a high voltage. The first voltage signal VGL is input to the pull-down point PD, and because the pull-up point PU maintains a high potential, the second transistor M2 is turned on, so that the second voltage signal VGH is transmitted to the first electrode s of the fifth transistor M5 through the second transistor M2. In this embodiment, because the voltage value of the second voltage signal VGH is greater than that of the first voltage signal VGL, a voltage value between the first gate g1 of the fifth transistor M5 and the first electrode s of the fifth transistor M5 is less than 0 V. According to the current-voltage characteristic curve of the thin film transistors, it can be concluded that a leakage current of the fifth thin film transistor M5 is greatly reduced, so that the leakage current of the pull-up point PU is greatly reduced.

In other possible embodiments, the regulation circuit 13 may also transmit the second voltage signal VGH to the first electrode s of the fourth transistor M4 and the first electrode s of the fifth transistor M5 at the same time, so that the leakage currents of the fourth transistor M4 and the fifth transistor M5 are reduced. It can be understood that the present disclosure does not limit an electrical connection mode of the regulation circuit 13 provided that the transmission of the second voltage signal VGH by the regulation circuit 13 to the enabling signal generation circuit 12 is not affected.

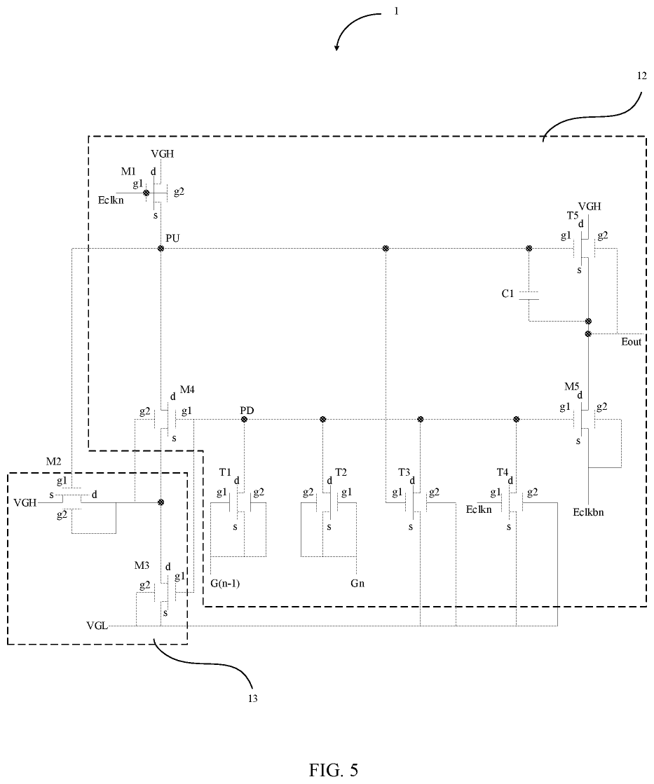

In a possible embodiment, referring to FIG. 5, FIG. 5 is a schematic diagram illustrating a light-emitting scanning signal drive circuit according to a fourth embodiment of the present disclosure. The enable signal generation circuit 12 further includes: a first switch transistor T1, a second switch transistor T2, a third switch transistor T3, a fourth switch transistor T4, a fifth switch transistor T5 and a storage capacitor C1; the first switch transistor T1, the second switch transistor T2, the third switch transistor T3, the fourth switch transistor T4 and the fifth switch transistor T5 each include a first gate g1, a second gate g2, a first electrode s and a second electrode d; the first gate g1 of the first switch transistor T1 is connected to the first electrode s of the first switch transistor T1 and the second gate g2 of the first switch transistor T1 and configured to receive a first scan signal G(n-1), the first scan signal G(n-1) is used to control on-off of the first switch transistor T1, and the second electrode d of the first switch transistor T1 is electrically connected to the pull-down point PD; the first gate g1 of the second switch transistor T2 is electrically connected to the first electrode s of the second switch transistor T2 and the second gate g2 of the second switch transistor T2 and configured to receive a second scan signal Gn, the second scan signal Gn is used to control on-off of the second switch transistor T2, and the second electrode d of the second switch transistor T2 is electrically connected to the pull-down point PD; the first gate g1 of the third switch transistor T3 is electrically connected to the pull-up point PU, the first electrode s of the third switch transistor T3 is electrically connected to the second gate g2 of the third switch transistor T3 and configured to receive the first voltage signal VGL, and the second electrode d of the third switch transistor T3 is electrically connected to the pull-down point PD; the first gate g1 of the fourth switch transistor T4 is configured to receive the first clock signal Eclkn, the first clock signal Eclkn is used to control on-off of the fourth switch transistor T4, the first electrode s of the fourth switch transistor T4 is electrically connected to the second gate g2 of the fourth switch transistor T4 and configured to receive the first voltage signal VGL, and the second electrode d of the fourth switch transistor T4 is electrically connected to the pull-down point PD; the first gate g1 of the fifth switch transistor T5 is electrically connected to the pull-up point PU, the first electrode s of the fifth switch transistor T5 is electrically connected to the second gate g2 of the fifth switch transistor T5 and the output terminal Eout, and the second electrode d of the fifth switch transistor T5 is configured to receive the second voltage signal VGH; one end of the storage capacitor C1 is electrically connected to the pull-up point PU, and the other end thereof is electrically connected to the output terminal Eout; the first gate g1 of the fifth transistor M5 is electrically connected to the pull-down point PD, the first electrode s of the fifth transistor M5 is electrically connected to the second gate g2 of the fifth transistor M5 and configured to receive a second clock signal Eclkbn, and the second electrode d of the fifth transistor M5 is electrically connected to the output terminal Eout.

Specifically, the first scan signal G(n-1) is used to control on-off of the first switch transistor T1. When the first switch transistor T1 is turned on, the first scan signal G(n-1) is transmitted to the pull-down point PD through the first switch transistor T1. The second scan signal Gn is used to control on-off of the second switch transistor T2. When the second switch transistor T2 is turned on, the second scan signal Gn is transmitted to the pull-down point PD through the second switch transistor T2. When the pull-up point PU maintains a high potential, the third switch transistor is turned on, so that the first voltage signal VGL is input to the pull-down point PD through the third switch transistor T3. The first clock signal Eclkn controls on-off of the fourth switch transistor T4. When the fourth switch transistor T4 is turned on, the first voltage signal VGL is transmitted to the pull-down point PD through the fourth switch transistor T4. When the fifth transistor M5 is turned on, the second clock signal Eclkbn is transmitted to the output terminal Eout through the fifth transistor M5.

It can be understood that the light-emitting scanning signal drive circuit 1 shown in FIG. 5 is an embodiment provided in the present disclosure. The present disclosure does not limit details of the light-emitting scanning signal drive circuit 1 provided that the regulation circuit 13 regulates a leakage current of the enable signal generation circuit 12 based on the second voltage signal VGH, so that the leakage current of the enable signal generation circuit 12 is reduced without adverse impact.

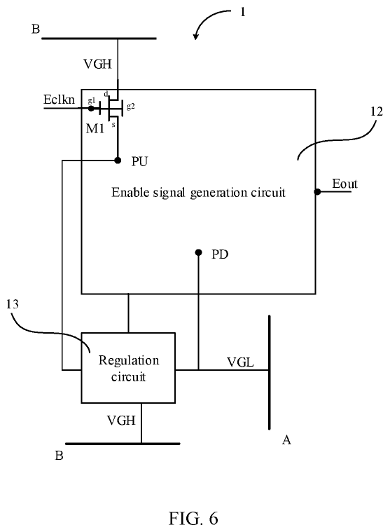

The present disclosure further provides a light-emitting scanning signal drive circuit 1. Referring to FIG. 6, FIG. 6 is a schematic diagram illustrating a light-emitting scanning signal drive circuit according to a second implementation of the present disclosure. The light-emitting scanning signal drive circuit 1 includes: a second voltage signal line B and an enable signal generation circuit 12, where the enable signal generation circuit 12 includes a pull-up point PU and a first transistor M1, the first transistor M1 includes a first gate g1, a second gate g2, a first electrode s and a second electrode d, the first gate g1 of the first transistor M1 is electrically connected to the second gate g2 and configured to receive a first clock signal Eclkn, the first clock signal Eclkn is used to control on-off of the first transistor M1, the first electrode s of the first transistor M1 is electrically connected to the pull-up point PU, the second electrode d of the first transistor M1 is electrically connected to the second voltage signal line B, and the first transistor M1 charges the pull-up point PU through the second voltage signal VGH.

Specifically, the second voltage signal line B generates a second voltage signal VGH, and the second voltage signal VGH is a direct current voltage signal. Compared with a conventional alternating current voltage signal, the second voltage signal VGH charges the pull-up point PU faster, which is beneficial to maintaining a voltage value of the pull-up point PU.

In a possible embodiment, referring to FIG. 6 again, the light-emitting scanning signal drive circuit 1 further includes a first voltage signal line A and a regulation circuit 13, where the enable signal generation circuit 12 is electrically connected to the first voltage signal line A; the enable signal generation circuit 12 further includes a pull-down point PD and an output terminal Eout, the pull-up point PU is electrically connected to the regulation circuit 13, the pull-down point PD is electrically connected to the regulation circuit 13, the regulation circuit 13 is electrically connected to the second voltage signal line B, and the enable signal generation circuit 12 generates a high-potential enable signal under a load of the first voltage signal line A and the second voltage signal line B and outputs the enable signal via the output terminal Eout, where a voltage value of the second voltage signal line B is greater than that of the first voltage signal line A.

Specifically, for the enable signal generation circuit 12 and the regulation circuit 13, refer to the above-mentioned description, which will not be repeated here. The first voltage signal line A generates a first voltage signal VGL, and a voltage value of the second voltage signal VGH is greater than that of the first voltage signal VGL. The regulation circuit 13 regulates a leakage current of the enable signal generation circuit 12 based on the second voltage signal VGH, so that the leakage current of the enable signal generation circuit 12 is reduced, thereby keeping the enable signal generated by the enable signal generation circuit 12 stable.

In a possible embodiment, the first voltage signal line A and the second voltage signal line B are both included in the inside of the light-emitting scanning signal drive circuit 1.

Specifically, because multiple nodes in the light-emitting scanning signal drive circuit 1 need to be simultaneously electrically connected to the first voltage signal line A and the second voltage signal line B, the first voltage signal line A and the second voltage signal line B save a design space and reduce a hardware cost of the light-emitting scanning signal drive circuit 1.

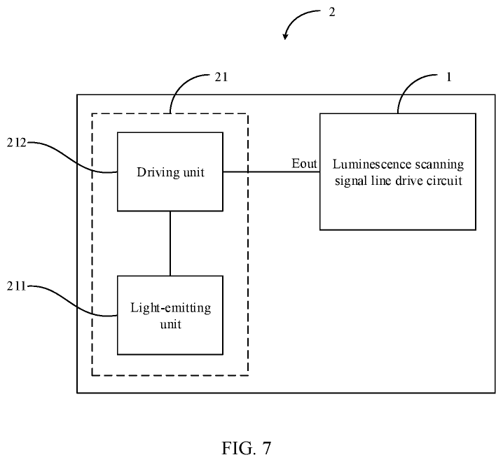

The present disclosure further provides a display panel 2. Referring to FIG. 7, FIG. 7 is a schematic block diagram illustrating a display panel according to an embodiment of the present disclosure. The display panel 2 includes the light-emitting scanning signal drive circuit 1 described above. For the light-emitting scanning signal drive circuit 1, refer to the above-mentioned description, which will not be repeated here.

Further, referring to FIG. 7 again, the display panel 2 further includes a pixel circuit 21, where the pixel circuit 21 includes a light-emitting unit 211 and a driving unit 212, and the pixel circuit 21 receives the enable signal output from the enable signal generation circuit 12 of the light-emitting scanning signal drive circuit 1, and the driving unit 212 drives the light-emitting unit 211 to emit light based on the enable signal.

It can be understood that in this embodiment, a voltage value of the enable signal generated by the light-emitting scanning signal drive circuit 1 is stable, so that when the driving unit 212 drives the light-emitting unit 211 to emit light, brightness of the light-emitting unit 211 does not change easily, and a display effect is good.

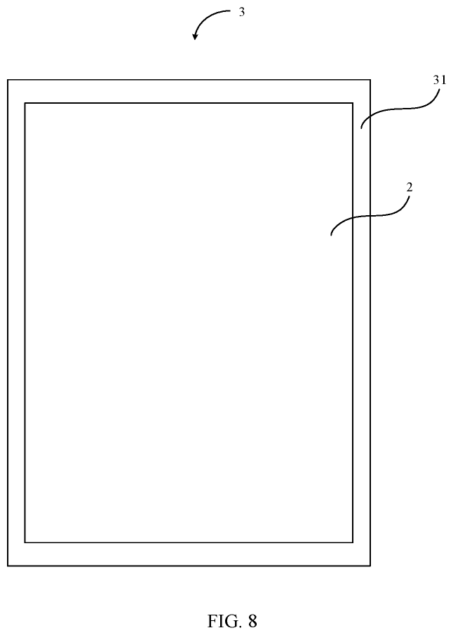

The present disclosure further provides an electronic device 3. Referring to FIG. 8, FIG. 8 is a schematic top view illustrating an electronic device according to an embodiment of the present disclosure. The electronic device 3 includes a body 31 and the display panel 2 described above, where the body 31 is configured to support the display panel 2.

Specific examples are applied herein to explain the principle and implementations of the present disclosure, and the above description of the embodiments is only intended to help understand the core idea of the present disclosure. In addition, for a person of ordinary skill in the art, there may be modifications in the specific implementations and disclosure scope based on the idea of the present disclosure. In conclusion, the content of the present specification should not be construed as a limitation to the present disclosure.

What is claimed is:

1. A light-emitting scanning signal drive circuit for a display panel, wherein the light-emitting scanning signal drive circuit comprises: a voltage signal generation circuit, an enable signal generation circuit and a regulation circuit, the voltage signal generation circuit is operable to generate a first voltage signal and a second voltage signal, the enable signal generation circuit receives the first voltage signal and comprises a pull-up point, a pull-down point and an output terminal, the pull-up point is electrically connected to the regulation circuit, the pull-down point is electrically connected to the regulation circuit, the regulation circuit is operable to receive the second voltage signal and input the second voltage signal to the enable signal generation circuit, and the enable signal generation circuit generates a high-potential enable signal based on the first voltage signal and the second voltage signal and outputs the high-potential enable signal via the output terminal, wherein a voltage value of the second voltage signal is greater than that of the first voltage signal.

2. The light-emitting scanning signal drive circuit according to claim 1, wherein the enable signal generation circuit comprises a first transistor, the first transistor comprises a first gate, a second gate, a first electrode and a second electrode, the first gate of the first transistor is electrically connected to the second gate of the first transistor and operable to receive a first clock signal, the first clock signal is used to control on-off of the first transistor, the first electrode of the first transistor is electrically connected to the pull-up point, the second electrode of the first transistor is operable to receive the second voltage signal, and the first transistor charges the pull-up point through the second voltage signal.

3. The light-emitting scanning signal drive circuit according to claim 1, wherein the regulation circuit comprises a second transistor and a third transistor, and the enable signal generation circuit comprises a fourth transistor; the second transistor, the third transistor and the fourth transistor each comprise a first gate, a second gate, a first electrode and a second electrode; the first gate of the second transistor is electrically connected to the pull-up point, the second gate of the second transistor is electrically connected to the second electrode of the third transistor, the first electrode of the second transistor is operable to receive the second voltage signal, and the second electrode of the second transistor is electrically connected to the second electrode of the third transistor; the first gate of the third transistor is electrically connected to the pull-down point, the first electrode of the third transistor is electrically connected to the second gate of the third transistor and operable to receive the first voltage signal, and the second electrode of the third transistor is electrically connected to the second gate of the fourth transistor; the first gate of the fourth transistor is electrically connected to the pull-down point, the second gate of the fourth transistor is electrically connected to the second electrode of the third transistor, the first electrode of the fourth transistor is electrically connected to the second electrode of the second transistor, and the second electrode of the fourth transistor is electrically connected to the pull-up point.

4. The light-emitting scanning signal drive circuit according to claim 3, wherein a voltage between the first gate and the first electrode of the fourth transistor is less than 0 V.

5. The light-emitting scanning signal drive circuit according to claim 1, wherein the regulation circuit comprises a second transistor and a third transistor, and the enable signal generation circuit comprises a fifth transistor; the second transistor, the third transistor and the fifth transistor each comprise a first gate, a second gate, a first electrode and a second electrode; the first gate of the second transistor is electrically connected to the pull-up point, the second gate of the second transistor is electrically connected to the first electrode of the second transistor and operable to receive the second voltage signal, and the second electrode of the second transistor is electrically connected to the second electrode of the third transistor; the first gate of the third transistor is electrically connected to the pull-down point, the second gate of the third transistor is electrically connected to the first gate of the fifth transistor and operable to receive the first voltage signal, and the second electrode of the third transistor is electrically connected to the first electrode of the fifth transistor; the second gate of the fifth transistor is electrically connected to the pull-down point, and the second electrode of the fifth transistor is electrically connected to the output terminal.

6. The light-emitting scanning signal drive circuit according to claim 5, wherein a voltage between the first gate and the first electrode of the fifth transistor is less than 0 V.

7. The light-emitting scanning signal drive circuit according to claim 1, wherein the enable signal generation circuit further comprises: a first switch transistor, a second switch transistor, a third switch transistor, a fourth switch transistor, a fifth switch transistor and a storage capacitor; the first switch transistor, the second switch transistor, the third switch transistor, the fourth switch transistor and the fifth switch transistor each comprise a first gate, a second gate, a first electrode and a second electrode; the first gate of the first switch transistor is electrically connected to the first electrode of the first switch transistor and the second gate of the first switch transistor and operable to receive a first scan signal, the first scan signal is used to control on-off of the first switch transistor, and the second electrode of the first switch transistor is electrically connected to the pull-down point; the first gate of the second switch transistor is electrically connected to the first electrode of the second switch transistor and the second gate of the second switch transistor and operable to receive a second scan signal, the second scan signal is used to control on-off of the second switch transistor, and the second electrode of the second switch transistor is electrically connected to the pull-down point; the first gate of the third switch transistor is electrically connected to the pull-up point, the first electrode of the third switch transistor is electrically connected to the second gate of the third switch transistor and operable to receive the first voltage signal, and the second electrode of the third switch transistor is electrically connected to the pull-down point; the first gate of the fourth switch transistor is operable to receive the first clock signal, the first clock signal is used to control on-off of the fourth switch transistor, the first electrode of the fourth switch transistor is electrically connected to the second gate of the fourth switch transistor and operable to receive the first voltage signal, and the second electrode of the fourth switch transistor is electrically connected to the pull-down point; the first gate of the fifth switch transistor is electrically connected to the pull-up point, the first electrode of the fifth switch transistor is electrically connected to the second gate of the fifth switch transistor and the output terminal, and the second electrode of the fifth switch transistor is operable to receive the second voltage signal; one end of the storage capacitor is electrically connected to the pull-up point, and the other end thereof is electrically connected to the output terminal; the first gate of the fifth transistor is electrically connected to the pull-down point, the first electrode of the fifth transistor is electrically connected to the second gate of the fifth transistor and operable to receive a second clock signal, and the second electrode of the fifth transistor is electrically connected to the output terminal

8. A light-emitting scanning signal drive circuit, comprising a second voltage signal line and an enable signal generation circuit, wherein the enable signal generation circuit comprises a pull-up point and a first transistor, the first transistor comprises a first gate, a second gate, a first electrode and a second electrode, the first gate of the first transistor is electrically connected to the second gate and operable to receive a first clock signal, the first clock signal is used to control on-off of the first transistor, the first electrode of the first transistor is electrically connected to the pull-up point, the second electrode of the first transistor is electrically connected to the second voltage signal line, and the first transistor charges the pull-up point through the second voltage signal.

9. The light-emitting scanning signal drive circuit according to claim 8, further comprising: a first voltage signal line and a regulation circuit, wherein the enable signal generation circuit is electrically connected to the first voltage signal line; the enable signal generation circuit further comprises a pull-down point and an output terminal, the pull-up point is electrically connected to the regulation circuit, the pull-down point is electrically connected to the regulation circuit, the regulation circuit is electrically connected to the second voltage signal line, and the enable signal generation circuit generates a high-potential enable signal under a load of the first voltage signal line and the second voltage signal line and outputs the enable signal via the output terminal, wherein a voltage value of the second voltage signal line is greater than that of the first voltage signal line.

10. The light-emitting scanning signal drive circuit according to claim 9, wherein the first voltage signal line and the second voltage signal line are both located in the inside of the light-emitting scanning signal drive circuit.

11. A display panel, comprising a light-emitting scanning signal drive circuit, for a display panel, wherein the light-emitting scanning signal drive circuit comprises: a voltage signal generation circuit, an enable signal generation circuit and a regulation circuit, the voltage signal generation circuit is operable to generate a first voltage signal and a second voltage signal, the enable signal generation circuit receives the first voltage signal and comprises a pull-up point, a pull-down point and an output terminal, the pull-up point is electrically connected to the regulation circuit, the pull-down point is electrically connected to the regulation circuit, the regulation circuit is operable to receive the second voltage signal and input the second voltage signal to the enable signal generation circuit, and the enable signal generation circuit generates a high-potential enable signal based on the first voltage signal and the second voltage signal and outputs the high-potential enable signal via the output terminal, wherein a voltage value of the second voltage signal is greater than that of the first voltage signal.

12. The display panel according to claim 11, further comprising a pixel circuit, wherein the pixel circuit comprises a light-emitting unit and a driving unit, and the pixel circuit receives the enable signal output from the enable signal generation circuit of the light-emitting scanning signal drive circuit, and the driving unit drives the light-emitting unit to emit light based on the enable signal.
